(19) United States
(12) Patent Application Publication
(10) Pub. No.: US 2024/0132380 A1
(43) Pub. Date: Apr. 25, 2024

(54) ELECTROCHEMICAL DEVICES WITH ENHANCED STABILITIES

(71) Applicant: PowerTech Water, Inc., Lexington, KY (US)

(72) Inventors: James Landon, Lexington, KY (US); Alan Rassoolkhani, Lexington, KY (US)

(21) Appl. No.: 18/078,304

(22) Filed: Dec. 9, 2022

Related U.S. Application Data
(60) Provisional application No. 63/287,688, filed on Dec. 9, 2021.
(60) Provisional application No. 63/375,708, filed on Sep. 15, 2022.

(51) Int. Cl. C02F 1/461; C02F 101/20

(52) U.S. Cl. CPC C02F 1/46109; C02F 2001/46142; C02F 2101/20; C02F 2201/46115

(57) ABSTRACT

An electrochemical device including at least one of a carbonaceous cathode, and at least one of a metal-containing anode. A separation distance between the carbonaceous cathode and the metal-containing anode is about 1 to about 5000 micrometers.

### CROSS-REFERENCE TO RELATED APPLICATIONS

This application claims benefit of U.S. Provisional Patent Application Ser. No. 63/287,688, filed Dec. 9, 2021, and U.S. Provisional Patent Application Ser. No. 63/375,708, filed Sep. 15, 2022, both of which are incorporated herein in their entirety.

### BACKGROUND

The present disclosure relates to electrochemical devices, and more particularly, to electrochemical devices with enhanced stabilities.

Various methods are used to remove heavy metals and other target species from wastewater and process water. Such methods include, for example, chemical precipitation, ion exchange, adsorption, membrane filtration, reverse osmosis, and electrochemical treatment. Electrochemical cells for removing heavy metals include one or more pairs of electrodes, an anode and a cathode, that remove or reduce the concentration of target species from an input stream and thereby provide an output stream with decreased content of the target species. In particular, when a sufficient external voltage (i.e., potential) is applied to the electrodes, non-spontaneous chemical reactions occur that reduce the concentration of target species (e.g., metal ions, halide ions, derivatives of target metals or target halides, or particulate metals) in the aqueous solution. Depending on the process conditions, e.g., applied voltage, pH, type and concentration of target species, electrode spacing, and cell design, target species are selectively removed from the aqueous solution by various processes, including physical adsorption to an electrode; electrical attraction (i.e., capacitive adsorption) to an electrode; and/or electron transfer reactions that directly or indirectly create new target species (i.e., Faradaic reactions) that become immobilized on an electrode.

### BRIEF DESCRIPTION

According to one or more embodiments, an electrochemical device includes at least one of a carbonaceous cathode and at least one of a metal-containing anode that includes a metal, wherein a separation distance between the carbonaceous cathode and the metal-containing anode is about 1 to about 5000 micrometers.

According to other embodiments, an electrochemical device includes a plurality of a cathode that includes a carbon felt and a plurality of an anode that includes a titanium mesh core coated with an alloy of titanium oxide, ruthenium oxide and iridium oxide. The electrochemical device further includes a membrane on one or more of the anodes that includes the titanium mesh core coated with the alloy of titanium oxide, ruthenium oxide and iridium oxide. A separation distance between the cathode that includes the carbon felt and the anode that includes the titanium mesh core coated with the titanium oxide, ruthenium oxide and iridium oxide is about 1 to about 5000 micrometers.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1A is a cross-sectional side view of a stacked electrochemical device;

FIG. 1B is a cross-sectional side view of a stacked electrochemical device with a membrane on the anode;

FIG. 1C is a cross-sectional side view of a stacked electrochemical device with a membrane on the cathode;

FIG. 1D is a cross-sectional side view of a stacked electrochemical device with a membrane on the anode and a membrane on the cathode;

FIG. 2 is a cross-sectional side view of another stacked electrochemical device;

FIG. 3 is a cross-sectional side view of a z-folded electrochemical device;

FIG. 4A is an exploded view of an electrode stack prior to rolling for a rolled cell electrochemical device;

FIG. 4B is a top view of the rolled electrodes of FIG. 4A;

FIG. 4C is a cross-sectional side view of a rolled electrochemical device;

FIG. 5 is a cross-sectional side view of another rolled electrochemical device;

FIG. 6 is a Pourbaix diagram for copper (Cu); and

FIG. 7 is a Pourbaix diagram for lead (Pb).

### DETAILED DESCRIPTION

Electrochemical devices with carbon-based (i.e., carbonaceous) electrodes provide highly efficient and environmentally friendly processes to remove and reduce the content of target species (e.g., heavy metals and other targets) from wastewater. By using the Pourbaix diagram (or potential/pH diagram) of the target species, which illustrates possible stable (equilibrium) phases of a target species in an aqueous electrochemical system, the desired applied potential (E) can be selected to selectively remove the target species on the anode or cathode.

While carbon-based electrochemical devices provide advantages of being highly selective, clean, and energy efficient, one challenge of using all carbon-based materials is that the devices are not stable over the long-term or after repeated cycles of applied voltages. Generally, the active surface area of the electrodes decreases from exposure to cycles of an applied voltage. For example, oxide groups form on the electrode surface, which causes pore roofing and pore collapse, resulting in increased resistance (referred to as bulk oxidation). Alternatively, oxide groups can form a resistive oxide layer (referred to as surface oxidation). Both scenarios require that the applied voltage increase, according to Ohm's law, to maintain the same amount of current to compensate for this increase in resistance: V=IR, where V is voltage (V), I is current (A), and R is resistance (Ω). Accordingly, the lifetime of an all-carbon electrochemical device, in which both electrodes are carbon-based, is generally only about or less than 1,000 hours of continuous operation.

Accordingly, described herein are electrochemical devices that include an asymmetric electrode configuration, including a carbon-based (i.e., carbonaceous) cathode, and a non-carbon anode, or in particular, a metal-based (i.e., metal-containing) anode. In embodiments, the metal-based anode includes a metal substrate with a metal oxide coating. In some embodiments, the electrochemical devices further include a membrane on the carbon-based cathode and/or on the metal-based anode. The membrane may be a cation exchange membrane or an anion exchange membrane, depending on which electrode the membrane is arranged on, or a bipolar membrane. Target species in an aqueous input stream are electroplated (i.e., plated or electrodeposited) on the carbon-based cathode. Both electrodes are stable for long periods of time and over repeated cycles, which allows for metal removal down to single digit parts per billion (ppb) in the output stream after treatment. The lifetimes of the asymmetric electrochemical devices described herein are greater than an all-carbon system, and in one or more embodiments, are greater than 1,000 hours of continuous operation. Replacing the carbon-based anode with a metal-based anode extends the lifetime and increases the stability of the electrochemical devices. All-carbon devices cannot support sufficiently high enough currents for metals concentrations above 10 ppm for long periods of time to effectively remove metals from a water stream. In all-carbon systems, the carbon will oxidize quickly, pores will collapse, and the device will ultimately fail. However, the metal-based anode allows oxygen to escape from the electrode, rather than oxidizing and degrading the surface, even at high applied voltages. The metal-based electrode surface cannot be appreciably oxidized into a dissolved state under most operating conditions, as it generally resists corrosion. In addition, the membrane(s) on the carbon-based cathode and/or on the metal-based anode further increases the performance and lifetime of the electrochemical device.

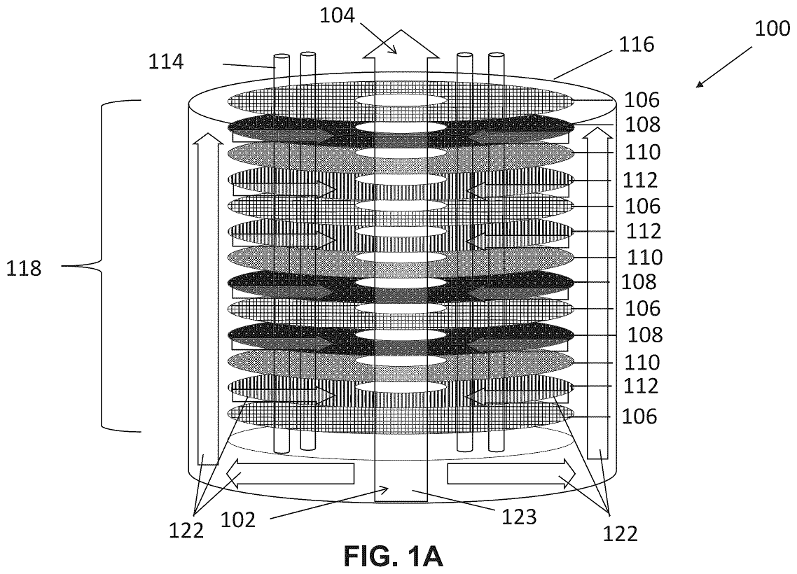

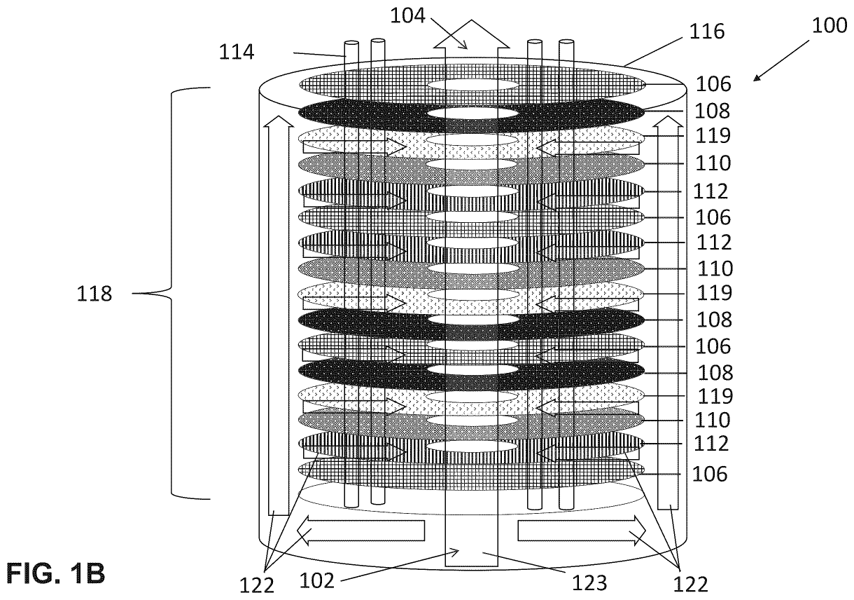

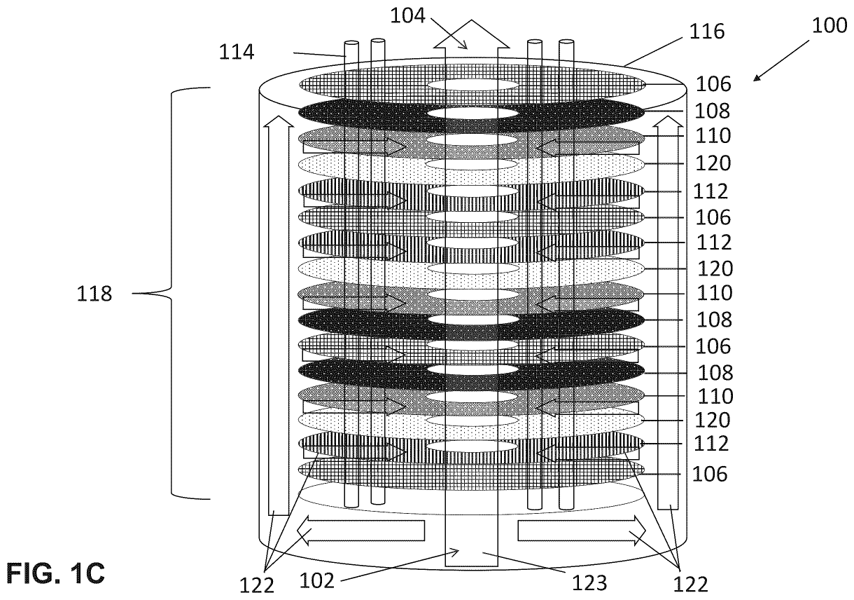

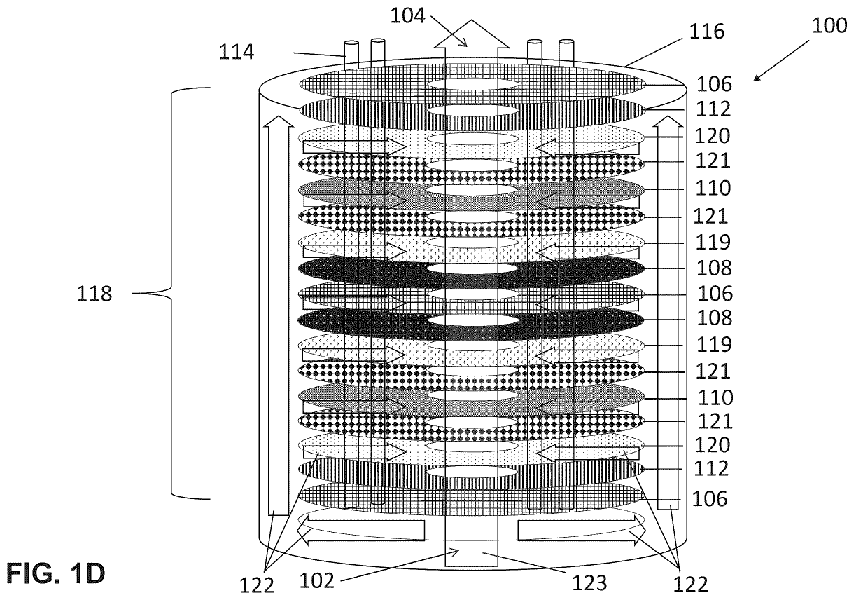

FIG. 1A illustrates an electrochemical device 100 that treats an input stream 102 of an aqueous solution (e.g., water) with one or more target species. FIG. 1B illustrates the electrochemical device 100 with a membrane 119 on the metal-based anode 108. FIG. 1C illustrates the electrochemical device 100 with a membrane 120 on the carbon-based cathode 112. FIG. 1D illustrates the electrochemical device 100 with a membrane 119 on the metal-based anode 108 and a membrane 120 on the carbon-based cathode 112.

The input stream 102 enters through an inlet in the housing 116 and is treated to at least partially remove or reduce the content of the one or more target species in the aqueous solution of the input stream 102, providing a treated output stream 104 that exits the housing 116 through an outlet. The output stream 104 includes a more reduced content of the target species than the input stream 102 and is then further processed as desired.

The electrochemical device 100 includes one or more electrode stacks 118 of a carbon-based cathode 112 and a metal-based anode 108 arranged in the housing 116. In some embodiments, as shown in FIGS. 1B and 1D, a membrane 119 (i.e., an anion exchange membrane) is arranged on the metal-based anode 108. In other embodiments, a membrane 120 (i.e., a cation-exchange membrane) is arranged on the carbon-based cathode 112.

Although one electrode stack 118 is shown, the electrochemical device 100 is not limited to one stack and in other embodiments includes one or more stacks 118, i.e., a plurality of electrode stacks 118 of the carbon-based cathode 112 and the metal-based anode 108. The electrochemical device 100 further includes electrical contacts 114 (or electrical connections) and associated wiring (not shown) between the electrodes. The electrical contacts 114 and associated wiring provide the necessary electrical connections to the electrical power supply (not shown). The carbon-based cathode 112 and the metal-based anode 108 are porous materials that allow for aqueous fluid flow therethrough in some embodiments. In other embodiments, the metal-based anode 108 is non-porous.

The electrochemical device 100 enables both a flow-by and a flow-through configuration. In the flow-by configuration, the input stream 102 flows across (indicated by arrows 122) the surfaces of the electrodes rather than through the electrodes. In the flow-through configuration, the input stream 102 flows through (indicated by arrows 123) the electrodes. The flow-by design provides advantages of lower pressure drop, higher flow rate, equal degradation of carbon electrodes, equivalent pH regions generated for each electrode pair. The flow-through design provides more extreme pH regions and improved control over the outlet pH. In stacked electrochemical devices as shown in FIGS. 1A-1D, in which the “stacked” electrodes are arranged in a parallel orientation with planar surfaces that are substantially parallel to one another, the input stream 102 flows-through the electrodes, flows-by the electrodes, or a combination thereof.

### Current Collector

In some embodiments, the electrode stack 118 includes one or more optional current collectors 106 attached to or in contact with one or both of the carbon-based cathode 112 and the metal-based anode 108. The current collectors 106 are, for example, sandwiched between layers of the carbon-based cathode 112, and between layers of the metal-based anode 108. The current collectors 106 are electric bridging components that collect electrical current generated at the attached electrode and reduce electrical losses within the electrochemical device 100. In one or more embodiments, the electrode stack 118 is compressed, and the current collectors 106 contact the electrodes. In some embodiments, the electrode is a film or a sheet that is cast onto the current collector 106. The current collector 106 attached to or in contact with the carbon-based cathode 112 and metal-based anode 108 are the same or different.

The current collectors 106 are solid or porous materials. Non-limiting examples of the current collectors 106 are films, layers, metal sheets, foil sheets, or mesh sheets. Non-limiting examples of materials for the current collectors 106 for the carbon-based cathode 112 include graphite, titanium, stainless steel, or a combination thereof. Non-limiting examples of materials of current collectors 106 for the metal-based anode 108 include graphite, titanium, stainless steel, aluminum, copper, nickel, or a combination thereof. In one or more embodiments, a current collector 106 is attached to or in contact with the carbon-based cathode 112, and a current collector 106 is not attached to or in contact with the metal-based anode 107.

In embodiments, the current collector 106 attached to either electrode is a planar structure with a thickness of about 0.01 to about 500 millimeters. In some embodiments, the current collector 106 has a thickness of about 0.1 to about 0.4 millimeters. In other embodiments, the current collector 106 has a thickness of about or in any range between about 0.01, 0.05, 0.1, 0.15, 0.20, 0.25, 0.30, 0.35, 0.40, 0.45, 0.50, 0.55, 0.60, 0.65, 0.70, 0.75, 0.80, 0.85, 0.90, 1, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, and 500 millimeters.

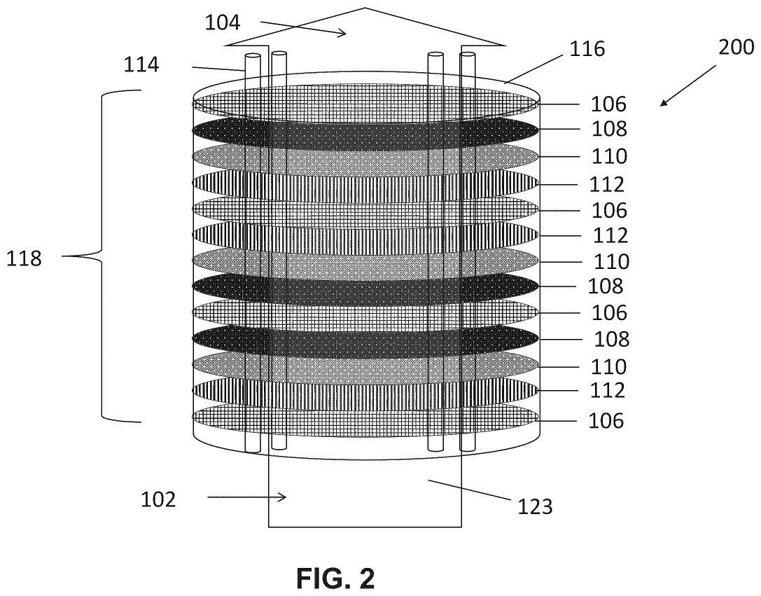

In some embodiments, each current collector 106 is a continuous planar structure without an annular hole therethrough, as shown in FIG. 2 for example. In other embodiments, each current collector 106 is a planar structure with an annular hole therethrough, as shown in FIGS. 1A-1D for example. In embodiments, the current collector 106 has a thin, planar, cylindrical shape, with or without an annular hole therethrough, as shown in FIGS. 1A-1D and 2, respectively. However, the shape of the current collector 106 is not limited to these shapes and can be any shape with the above-described thickness.

In embodiments as shown in FIGS. 1A-1D, the current collectors 106 are solid (non-porous), and each of the carbon-based cathode 112 and metal-based anode 108 is porous, which allows for both flow-by (arrows 122) and flow-through (arrows 123) flow path configurations. In other embodiments as shown in FIG. 2, the current collectors 106, carbon-based cathode 112, and metal-based anode 108 are all porous materials, allowing flow-through (arrows 123) the electrode stack 118 of the electrochemical device 200.

### Separator

In one or more embodiments, the electrode stacks 118 further include a separator 110 arranged between the carbon-based cathode 112 and the metal-based anode 108. The separator 110 is a dielectric material and prevents physical and electrical contact between the electrodes. Non-limiting examples of dielectric materials for the separator 110 include polymeric materials, cellulosic-based materials, silica-based materials, or any combination thereof. In some embodiments, the separator 110 includes polyethylene.

In embodiments, the separator 110 is a planar structure with a thickness of about 1 to about 5000 micrometers. In some embodiments, the separator 110 has a thickness of about 50 to about 250 micrometers. In other embodiments, the separator 110 has a thickness about, less than or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and 5000 micrometers.

The thickness of the separator 110 that separates the carbon-based cathode 112 from the metal-based anode 108 defines the separation distance between the electrodes. The separation distance between the stacked, or parallel arranged, carbon-based cathode 112 and metal-based anode 108, is critical. The electrodes must be close enough to support viable separation. If the electrodes are too far apart, separation is not viable. Removal rate is directly proportional to the separator distance with larger distances leading to greater resistance. With separator distances greater than 1000 microns, the removal rate continues to drop precipitously, increasing the voltage required for operation and the likelihood for water splitting to occur, hurting the efficiency of the process. At distances of less than 1 micron, while the reaction rate may be high, the possibility for short circuiting of the cell due to metal deposits connecting between the anode and the cathode, often referred to as dendrites, becomes quite high. Therefore, for practical operation where both high removal rates can be achieved along with reliable operation, a distance of 1-5000 microns is critical. Thus, the separation distance between the carbon-based cathode 112 and the metal-based anode 108 is about 1 to about 1000 micrometers, as described above, in some embodiments. In other embodiments, the separation distance between the carbon-based cathode 112 and the metal-based anode 108 is about or in any range between about 1, 25, 50, 75, 100, 125, 150, 175, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, 1800, 1825, 1850, 1875, 1900, 1925, 1950, 1975, 2000, 2025, 2050, 2075, 2100, 2125, 2150, 2175, 2200, 2225, 2250, 2275, 2300, 2325, 2350, 2375, 2400, 2425, 2450, 2475, 2500, 2525, 2550, 2575, 2600, 2625, 2650, 2675, 2700, 2725, 2750, 2775, 2800, 2825, 2850, 2875, 2900, 2925, 2950, 2975, 3000, 3025, 3050, 3075, 3100, 3125, 3150, 3175, 3200, 3225, 3250, 3275, 3300, 3325, 3350, 3375, 3400, 3425, 3450, 3475, 3500, 3525, 3550, 3575, 3600, 3625, 3650, 3675, 3700, 3725, 3750, 3775, 3800, 3825, 3850, 3875, 3900, 3925, 3950, 3975, 4000, 4025, 4050, 4075, 4100, 4125, 4150, 4175, 4200, 4225, 4250, 4275, 4300, 4325, 4350, 4375, 4400, 4425, 4450, 4475, 4500, 4525, 4550, 4575, 4600, 4625, 4650, 4675, 4700, 4725, 4750, 4775, 4800, 4825, 4850, 4875, 4900, 4925, 4950, 4975, and 5000 micrometers.

In some embodiments, each separator 110 is a continuous planar structure without an annular hole therethrough, as shown in FIG. 2 for example. In other embodiments, each separator 110 is a planar structure with an annular hole therethrough, as shown in FIGS. 1A-1D for example. In embodiments, the separator 110 has a thin planar cylindrical shape, with or without an annular hole therethrough, as shown in FIGS. 1A-1D and 2, respectively. However, the shape of the separator 110 is not limited to these shapes and can be any shape with the above-described thickness.

### Carbon-Based Cathode

The carbon-based cathode 112 is a carbon-based material. Non-limiting examples of the carbon-based material include carbon cloths, carbon films, activated carbon materials, non-wovens (e.g. carbon felts, carbon aerogels, etc.), or any combination thereof.

Carbon cloths are woven, conductive, porous materials that either consist of or consist essentially of carbon. Woven cloths are textiles formed by weaving. The woven cloths have a high void fraction. Void ratio (or void fraction) describes the open porosity of a carbon material and how easily an aqueous solution can flow through the carbon material. The void ratio (also referred to as void fraction) is a measurement of the amount of aqueous solution (or water) displaced by a piece of carbon material of known dimensions and mass according to the following equation:

Void ratio (%)=V_{carbon}−V_{water displaced}/V_{carbon}

where V_{carbon} is the volume of the carbon, V_{water} displaced is the volume of water (or aqueous solution) displaced. The units of V_{carbon} and V_{water} displaced are the same, resulting in a void ratio (%). In some embodiments, the woven cloths have a void fraction (also referred to as a void ratio) about 65% to about 99.9%. In other embodiments, the woven cloths have a void fraction of about 70% to about 99.9%. Still yet, in embodiments, the woven cloths have void fractions about or in any range between about 65%, 68%, 70%, 72%, 75%, 78%, 80%, 82%, 85%, 88%, 90%, 92%, 95%, 97%, 99%, and 99.9%.

In some embodiments, the woven cloths have a high surface area of about 700 to about 2300 square meters per gram. In other embodiments, the woven cloths have a high surface area of about 1200 to about 2300 square meters per gram. Yet, in other embodiments, the woven cloths have a high surface area about or in any range between about 700, 750, 800, 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram.

In other embodiments, the woven cloths have a low surface area of about 0.1 to about 5 square meters per gram. Yet, in embodiments, the woven cloths have a low surface area about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram.

A non-limiting example of a woven cloth for the carbon-based cathode 112 is a high void fraction (about 65% to about 99.9%) and high surface area (about 700 to about 2300 square meters per gram) material. Another non-limiting example of a woven cloth for the carbon-based cathode 112 is a high void fraction (about 70% to about 99.9%) and high surface area (about 1200 to about 2300 square meters per gram) material.

Carbon felts are non-woven porous materials that consist of or consist essentially of carbon. In some embodiments, the carbon felts are activated carbon felts. In other embodiments, the carbon felts are thermally treated or surface oxidized carbon felts. In one or more embodiments, the carbon felt has a void fraction of about or greater than 95%. In other embodiments, the carbon felt has a void fraction of about, greater than, or in any range between about 95%, 96%, 97%, 98%, 99%, and 99.9%, for example about 95% to about 99%, about 95% to about 98%, about 95% to about 97%, and about 95% to about 96%. In one or more embodiments, the carbon felt has a void fraction of about 70% to about 99.9%. In other embodiments, the carbon felt has a void fraction of about or in any range between about 70%, 72%, 75%, 77%, 80%, 82%, 85%, 87%, 90%, 92%, 95%, 97%, 99%, and 99.9%.

In some embodiments, the carbon felt has a low surface area of less than 5 square meters per gram. Still yet, in other embodiments, the carbon felt has a low surface area of about or in any range between about 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, and 5.0 square meters per gram. In some embodiments, the carbon felt has a high surface area of about 1200 to about 2300 square meters per gram. Still yet, in other embodiments, the carbon felt has a surface area of about or in any range between about 1200, 1250, 1300, 1350, 1400, 1450, 1500, 1550, 1600, 1650, 1700, 1750, 1800, 1850, 1900, 1950, 2000, 2050, 2100, 2150, 2200, 2250, and 2300 square meters per gram.

A non-limiting example of a carbon felt for the carbon-based cathode 112 is a high void fraction (about or greater than 95%) and low surface area (about 0.1 square meters per gram to about 5 square meters per gram) material. Another non-limiting example of an activated carbon felt for the carbon-based cathode 112 is a high void fraction (about 70% to about 99.9%) and high surface area (about 1200 to about 2300 square meters per gram) material.

Carbon films are carbon composites that consists of or consists essentially of carbon particles and a carbon binder. In one or more embodiments, the carbon film is an activated carbon film that is microporous and includes a binder. Non-limiting examples of the binder of the activated carbon film include polyvinylidene fluoride (PVDF), polytetrafluoroethylene (PTFE), sodium alginate, sodium-carboxymethyl cellulose, an ion exchange polymer, or a combination thereof.

In one or more embodiments, the activated carbon film has a void fraction of about 30% to about 65%. In other embodiments, the activated carbon film electrode has a void fraction of about 30% to about 60%. Still yet, in other embodiments, the activated carbon film has a void fraction of about or in any range between about 30%, 35%, 40%, 45%, 50%, 55%, 60%, and 65%.

In some embodiments, the activated carbon film has a surface area of about 1200 to about 1400 square meters per gram. Still yet, in other embodiments, the activated carbon film has a surface area of about or in any range between about 1200, 1220, 1240, 1260, 1280, 1300, 1320, 1320, 1340, 1360, 1380, and 1400 square meters per gram.

A non-limiting example of an activated carbon film for the carbon-based cathode 112 is a low void fraction (about 30% to about 65%) and high surface area (about 1200 to about 1400 square meters per gram) material.

In embodiments, the carbon-based cathode 112 is a planar structure with a thickness of about 0.1 to about 50 millimeters. In some embodiments, the carbon-based cathode 112 has a thickness of about 2 to about 5 millimeters. In other embodiments, the carbon-based cathode 112 has a thickness about or in any range between about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 4.7, 4.8, 3.9, 4.0, 4.1, 4.2, 4.3, 4.4, 4.5, 4.6, 4.7, 4.8, 4.9, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, 10.0, 10.5, 11.0, 11.5, 12.0, 12.5, 13.0, 13.5, 14.0, 14.5, 15.0, 15.5, 16.0, 16.5, 17.0, 17.5, 18.0, 18.5, 19.0, 19.5, 20.0, 20.5, 21.0, 21.5, 22.0, 22.5, 23.0, 23.5, 24.0, 24.5, 25.0, 25.5, 26.0, 26.5, 27.0, 27.5, 28.0, 28.5, 29.0, 29.5, 30.0, 30.5, 31.0, 31.5, 32.0, 32.5, 33.0, 33.5, 34.0, 34.5, 35.0, 35.5, 36.0, 36.5, 37.0, 37.5, 38.0, 38.5, 39.0, 39.5, 40.0, 40.5, 41.0, 41.5, 42.0, 42.5, 43.0, 43.5, 44.0, 44.5, 45.0, 45.5, 46.0, 46.5, 47.0, 47.5, 48.0, 48.5, 49.0, 49.5, and 50.0 millimeters.

In some embodiments, each carbon-based cathode 112 is a continuous planar structure without large apertures therethrough, as shown in FIG. 2 for example. In other embodiments, each carbon-based cathode 112 is a planar structure with an annular hole therethrough, as shown in FIGS. 1A-1D for example. In embodiments, the carbon-based cathode 112 has a thin planar cylindrical shape, with or without an annular hole therethrough, as shown in FIGS. 1A-1D and 2, respectively. However, the shape of the carbon-based cathode 112 is not limited to these shapes and can be any shape with the above-described thickness.

In some embodiments, the carbon-based cathode 112 consists of a single homogenous layer of a carbon material, such as a woven carbon cloth, a carbon felt, or a carbon film.

In embodiments, electrochemical devices include a plurality of cathodes, and every cathode is a carbon-based cathode 112. In one or more embodiments, electrochemical devices do not include other types of cathodes. In some embodiments, the electrochemical devices include a plurality of cathodes, and all of the cathodes are the same carbon-based cathode 112.

In embodiments, electrochemical devices include a plurality of anodes, and every anode is a metal-based anode 108. In one or more embodiments, electrochemical devices do not include other types of anodes. In some embodiments, the electrochemical devices include a plurality of anodes, and all of the anodes are the same metal-based anode 108.

### Metal-Based Anode

In one or more embodiments, the metal-based anode 108 includes a metal substrate. In other embodiments, the metal-based anode 108 includes a metal substrate with a metal oxide coating. The metal substrate is any coatable metal or metal alloy. The metal substrate can include plates, rods, tubes, wires or knitted wires, and/or expanded meshes of metals or metal alloys. Non-limiting examples of metals for the metal substrate include titanium, tantalum, aluminum, zirconium, niobium, or any combination or alloy thereof. Non-limiting examples of metal alloys for the metal substrate include titanium nickel alloys, titanium cobalt alloys, titanium iron alloys, titanium copper alloys, or any combination thereof.

According to some embodiments, the metal substrate is a titanium mesh. In one or more embodiments, the metal-based anode includes about 5 grams per square meter (g/m²) of precious metal, but is not limited to this amount. For example, the metal-based anode includes less than 2 g/m², or greater than 8 g/m² of precious metal. In some embodiments, the metal-based anode 108 includes about 1 g/m² to about 10 g/m² precious metal, about 2 g/m² to about 8 g/m² precious metal, about 3 g/m² to about 7 g/m² precious metal, or about 4 g/m² to about 6 g/m² precious metal. Non-limiting examples of the precious metal include platinum, gold, or any combination or alloy thereof.

Before applying the metal oxide coating, the metal substrate is optionally cleaned to obtain a clean metal surface. The metal substrate is cleaned by, for example, mechanical cleaning, degreasing, chemical or electrolytic cleaning, or any combination thereof. Optionally, the metal base is etched to obtain a surface roughness or surface morphology. For example, acids, e.g., hydrochloric, sulfuric, perchloric, nitric, oxalic, tartaric, phosphoric acids, or combinations thereof, or caustic compounds, e.g., potassium hydroxide/hydrogen peroxide, are used to chemically etch the surface of the metal base. Plasma spraying is another example of a process used for providing a roughened metal surface.

Once prepared, the metal substrate is coated with one or more metal oxides. Non-limiting examples of metal oxides include platinum oxide, palladium oxide, rhodium oxide, iridium oxide, ruthenium oxide, titanium oxide, mixtures thereof, or mixtures with other metals. Other non-limiting examples of metal oxides include manganese dioxide, lead dioxide, cobalt oxide, ferric oxide, nickel-nickel oxide, nickel plus lanthanide oxides, platinate coatings such as MₓPt₃O₄ where M is an alkali metal, and x is typically targeted at approximately 0.5, or any combination thereof.

The metal oxide precursors for the coating are combined in a coating composition and applied to the metal substrate by any process that applies a liquid coating composition to a metal substrate. Such methods include dip spin and dip drain techniques, brush applications, roller coating and spray applications, such as electrostatic spraying. Once a uniform coating is applied to the metal substrate, heat is applied to the coated metal substrate to effect thermal decomposition of the precursors and form the metal oxide coating. Heating is performed, for example, at a temperature of about 425 to about 535 degrees Celsius for about 3 to about 20 minute and is performed in an oxidative environment, such as in air or in oxygen.

In one or more embodiments, the metal oxide coating on the metal substrate includes ruthenium oxide, iridium oxide, titanium oxide, or a combination thereof. Ruthenium chloride (RuCl₃), iridium chloride (IrCl₃ or H₂IrCl₃), and titanium isopropoxide (Ti{OCH(CH₃)₂}₄), commonly referred to as titanium tetraisopropoxide or TTIP, are combined as precursors in a coating composition, which are deposited on the surface of the metal substrate to form the metal-based anode 108.

In one or more embodiments, the metal-based anode 108 is a planar structure with a thickness of about 0.1 to about 3 millimeters. In some embodiments, the metal-based anode 108 has a thickness of about 0.1 to about 1.2 millimeters. In other embodiments, the carbon-based cathode has a thickness about or in any range between about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, and 3.0 millimeters.

In some embodiments, each metal-based anode 108 is a planar structure with an annular hole therethrough, as shown in FIGS. 1A-1D for example. In embodiments, the metal-based anode 108 has a thin planar cylindrical shape, with or without an annular hole therethrough, as shown in FIGS. 1A-1D and 2, respectively. However, the shape of the metal-based anode 108 is not limited to these shapes and can be any shape with the above-described thickness.

### Membrane

In one or more embodiments, the membrane 119 and 120 (FIGS. 1B-1D) is an ion exchange membrane. In embodiments, an anion exchange membrane 119 is used when the membrane is on the metal-based anode, and/or a cation exchange membrane 120 is used when the membrane is on the carbon-based cathode. A cation exchange membrane is a membrane that is selectively permeable to cations. An anion exchange membrane is a membrane that is selectively permeable to anions. The membrane is in a form of a film, a layer, a sheet, a coating, or a combination thereof, and the membrane is arranged on a surface of an electrode (thus, the metal-based anode and/or the carbon-based cathode) or is free-standing. The membrane is on, directly on, or in contact with the electrode in some embodiments. In other embodiments, the membrane surrounds the electrode. In other embodiments, the ion exchange membrane is a bipolar membrane.

### Electrode Configurations

To make the electrode stacks of the electrochemical devices described herein, the above-described layers of the cell, including the carbon-based cathode 112, metal-based anode 108, current collectors 106, separators 110, and in some embodiments, the membrane 119 and membrane 120 are stacked upon one other in any order provided that the carbon-based cathode 112 is separated from the metal-based anode 108 by the separator 106 and at the critical separation distance described herein. As a result, the separator 106 is between the metal-based anode 108 and the carbon-based cathode 112. Current collectors 106 are layered to separately contact each of the metal-based anode 108 and the carbon-based cathode 112.

In one or more embodiments, the membrane 120 (FIGS. 1C and 1D) (cation exchange membrane) is on a first surface of the carbon-based cathode 112 opposite a second surface of the carbon-based cathode 112 which is in contact with the current collector 106. Thus, the membrane 120 contacts the carbon-based cathode 112 and the separator 106. In other embodiments, the membrane 119 (FIGS. 1B and 1D) (anion exchange membrane) is on a first surface of the metal-based anode 108 opposite a second surface of the metal-based anode 108 which is in contact with the current collector 106. Thus, the membrane 119 contacts the metal-based anode 112 and the separator 106.

Another layer of each of the metal-based anode 108 and carbon-based cathode 112 can be layered on the current collector 106, such that the current collectors 106 are sandwiched between contacting layers of each of the metal-based anode 108 carbon-based cathode 112. In one or more embodiments, a current collector 106 is sandwiched between layers of the carbon-based cathode 112, and a current collector 106 is not attached to or in contact with the metal-based anode 108.

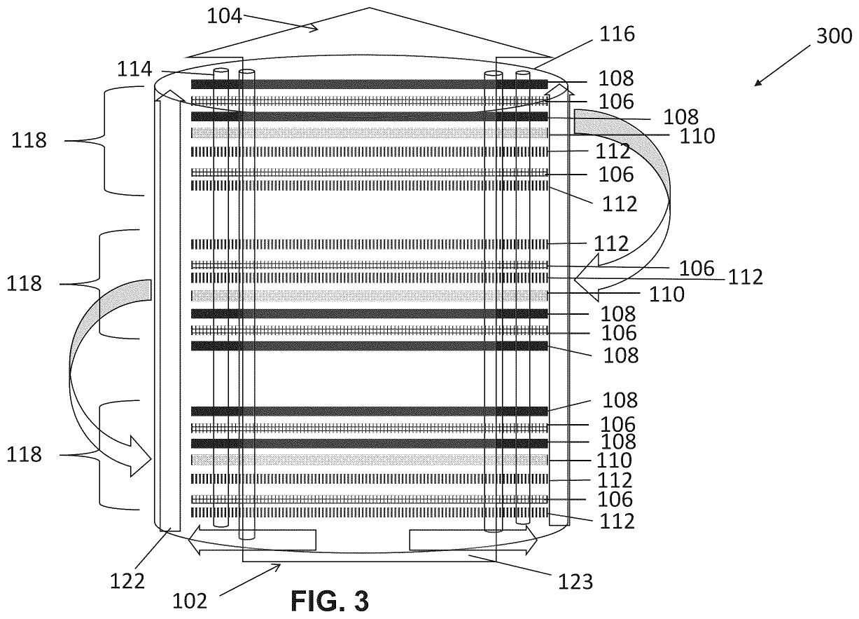

The carbon-based cathode 112 and metal-based anode 108 are spaced apart from one another and arranged in the electrode stacks 118 of the electrochemical devices in various configurations. In addition to the stacked electrode flow-by and flow-through device configurations as shown in FIGS. 1A-1D and 2, the electrochemical devices have other configurations. FIG. 3 is a cross-sectional side view of a z-folded electrode configuration of an electrochemical device 300. The electrode stack 118 (including the carbon-based cathode 112, metal-based anode 108, current collectors 106, and separator 108) is folded in a z-shape pattern, which allows the input stream 102 to flow-through (arrows 123) the electrode stack 118 and to flow-by (arrows 122) the electrode stack 118.

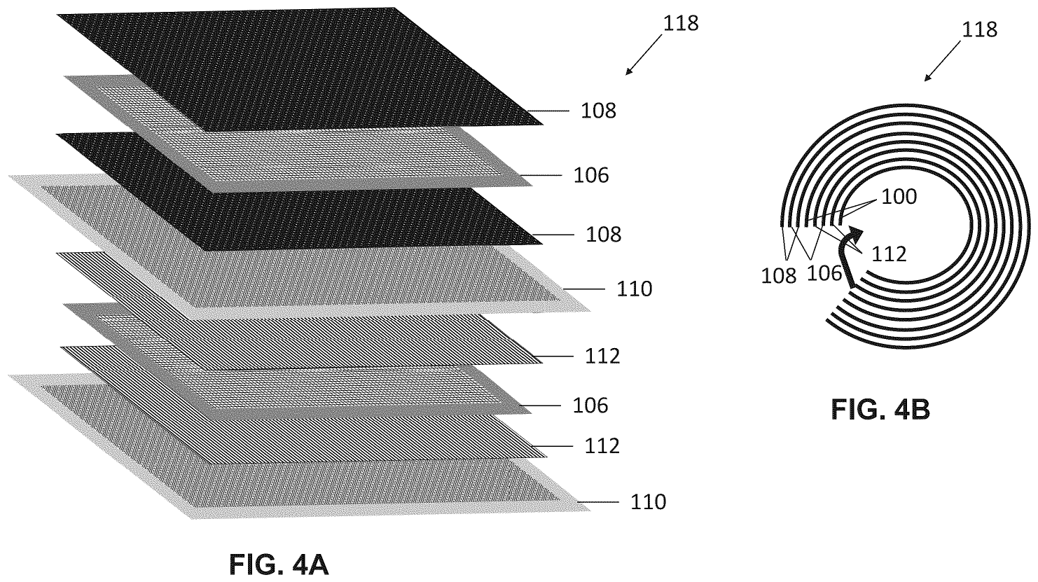

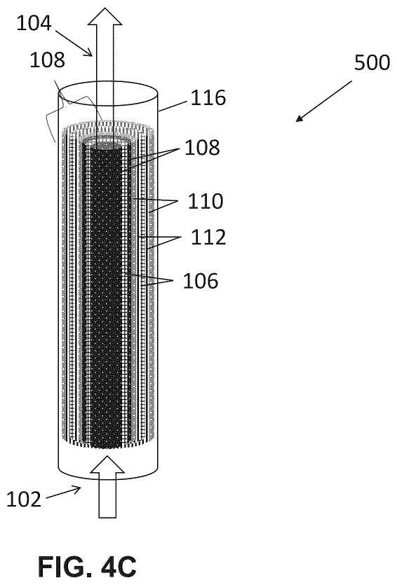

FIGS. 4A-4C illustrate a rolled electrode stack for a rolled electrochemical device for axial flow stream flow through the electrode stack 118. FIG. 4A is an exploded view of an electrode stack 118 prior to rolling for a rolled cell electrochemical device. FIG. 4B is a top view of the rolled electrode stack 118 of FIG. 4A. FIG. 4C is a cross-sectional side view of a rolled electrochemical device including the electrode stack 118 shown in FIGS. 4A and 4B. The electrode stack 118 includes metal-based anodes 108 separated from carbon-based cathodes 112 by separators 110, along with current collectors 106 attached to the metal-based anodes 108 and carbon-based cathodes 112. The electrode stack 118 (FIG. 4A) is physically rolled into a spiral to create a cylinder (FIG. 4B) with multiple, predominantly flow-by, through stream paths through the porous carbon electrodes. To make a rolled electrochemical device, single continuous sheets of anode material, separator material, and cathode material are stacked and then rolled up to form a cylinder. Current collectors are attached to the anode and the cathode, usually in multiple locations to reduce electrical losses. The input stream 102 flows through, axially, as well as flows-by the rolled electrode stack 118.

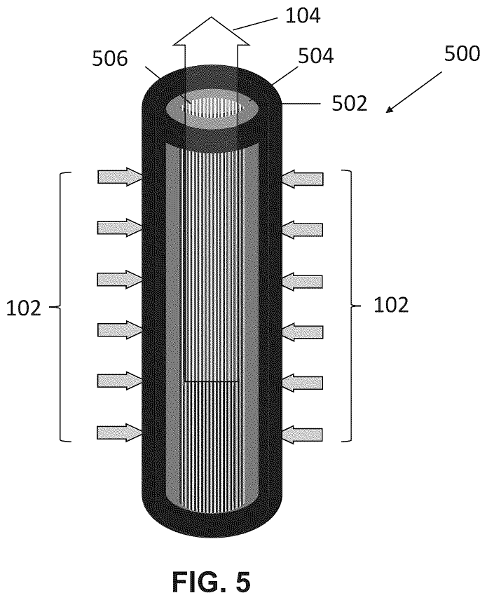

FIG. 5 is a cross-sectional side view of a rolled electrochemical device 500 for radial stream flow. The input stream 102 flows radially through the rolled electrochemical device 500. The electrode stack includes a first electrode 502, a separator 504, and a second electrode 506. In some embodiments, the first electrode 502 is the carbon-based cathode 112, and the second electrode 506 is the metal-based anode 108. In other embodiments, the first electrode 502 is the metal-based anode 108, and the second electrode 506 is the carbon-based cathode 112. Current collectors described above may be attached to one or both of the first electrode 502 and the second electrode 506. Electrical connections (not shown) can be made at the top of the electrodes or with an incorporated conductive mesh. While one of each of a first electrode 502 and second electrode 506 are shown in FIG. 5, in one or more embodiments, the electrode stack includes a plurality of each of the first electrode 502 and second electrode 506, with the separator 504 therebetween.

An optional feed channel or spacer 121 may be present in the electrochemical device as shown in FIG. 1D. The feed channel or spacer 121 can create a larger flow channel for the through stream. Non-limiting examples of a form of the feed channel or spacer 121 are a netting or mesh. Non-limiting examples of materials for the feed channel or spacer 121 include polypropylene, polyethylene, nylon, or a combination thereof.

### Electroplating

Electrochemical devices described herein are used to purify aqueous solutions by at least partially removing or reducing the target ionic species from the aqueous solution. The input stream of aqueous solution is an industrial wastewater stream or a residential water stream, for example. The aqueous solution of the input stream includes salts and/or ions of target ionic species. Non-limiting examples of the target ionic species, e.g., metals, include silver (Ag), copper (Cu), chromium (Cr), lead (Pb), cadmium (Cd), nickel (Ni), zinc (Zn); halides, e.g., chlorine (Cl); halide derivatives, e.g., chloramine, or any combination thereof. In some embodiments, the chromium is Cr (VI), which is reduced to Cr (III) on the carbon-based cathode 112.

The starting concentration of target species in the input stream varies depending on the particular species. In one or more embodiments, the starting concentration (parts per million/ppm) of the target species is 0.1 to about 10,000 parts per million. In other embodiments, the starting concentration of the target species is about 0.1 to about 100 parts per million.

The electrochemical device with the electrode cell stack is connected to a power supply via the electrical connectors and wiring, and a controller applies a potential (E+ or E−) to the electrodes. The asymmetry of the electrodes provides a voltage distribution across the electrodes, which equates to a different voltage at each electrode that controls the speciation of the target ionic species at the electrodes. A negative potential, or voltage, is applied to the carbon-based cathode, and a positive potential, or voltage, is applied to the metal-based anode. As a result, the removal of the target ionic species can be forced to occur predominately by plating on the carbon-based cathode, as explained in detail below. The applied voltage is split between the carbon-based cathode and the metal-based anode according to the electrodes' material properties, such as mass, area, surface area, resistance, etc. For example, if 1.6 V is applied to the device, the carbon-based cathode may have an applied voltage of −0.9 V versus standard calomel electrode (SHE) and the metal-based anode may have an applied voltage of +0.7 V versus SHE.

Upon application of a voltage/potential to the electrochemical device, the target species are removed or reduced from the aqueous solution by various processes, including physical adsorption to an electrode; electrical attraction (capacitive adsorption) to an electrode; electron transfer reactions that directly or indirectly create new target species (Faradaic reactions) that become immobilized on an electrode. Electroplating (also referred to as electrodeposition or plating) used in the herein described electrochemical devices removes the target species from the aqueous solution by reduction to form a solid lead metal (i.e., Pb²⁺ in solution is electroplated as Pb(s)) on the carbon-based cathode 112. The applied voltage is selected to effect electroplating of target species on the carbon-based cathode 112.

The Pourbaix diagram of the target species is used to select the voltage and pH conditions to electroplate the target species on the carbon-based cathode 112. A Pourbaix diagram is specific for a particular species and shows potential/voltage (y-axis) as a function of pH (x-axis). The Pourbaix diagram illustrates possible stable (equilibrium) phases of the target species in an aqueous electrochemical system. The desired applied potential (E) is selected and applied to electroplate (or electrodeposit) the target species on the carbon-based cathode 112 (the electrode which a negative potential will be applied). The Pourbaix diagram for each target species in the aqueous solution is used to determine the operating conditions (i.e., electrode voltage and pH) under which the target species will be removed or partially removed (by Faradaic reactions) from the aqueous solution by electroplating as a reduced solid. Pourbaix diagrams for various target species are available from various sources, including for example, Pourbaix, Marcel, Atlas of Electrochemical Equilibria in Aqueous Solutions, Houston, TX, National Association of Corrosion Engineers, 1974, incorporated herein in its entirety by reference.

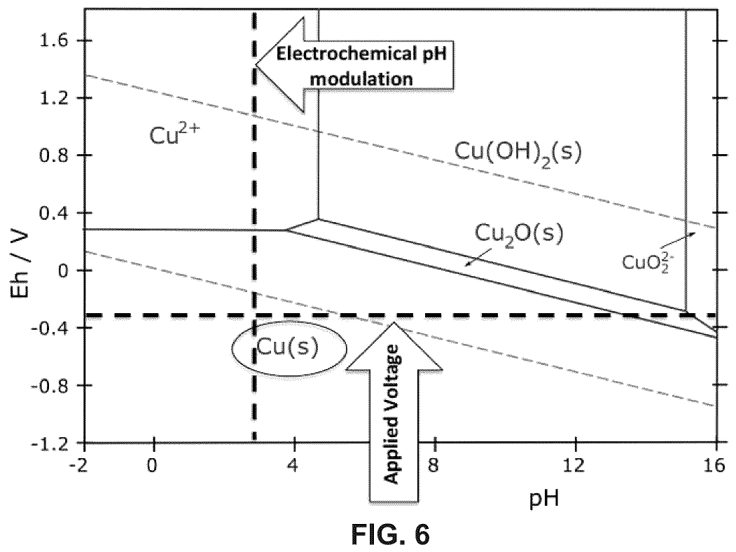

An example of a Pourbaix diagram for copper is shown in FIG. 6. Predominant ion boundaries are represented by lines, and as such, the Pourbaix diagram is read much like a standard phase diagram with a different set of axes, with potential (V) on the y-axis, and pH on the x-axis. The bulk aqueous solution includes copper ions as Cu²⁺, which are immobilized as Cu(OH)₂ (s) and Cu₂O(s) when oxidized under alkaline conditions, and electroplated as Cu(s) on the cathode under the shown operating conditions. In particular, when applying a voltage of −0.3 V to the carbon-based cathode as illustrated by the horizontal line, the pH (illustrated by the vertical line) is modulated such that the intersection with the potential (horizontal line) represents the species of the metal that will exist under those conditions. For example, with an applied voltage of about −0.3 V to about −0.4 V versus a normal hydrogen electrode (NHE), copper (Cu(s)) is plated on the cathode when the pH 0 to 14.

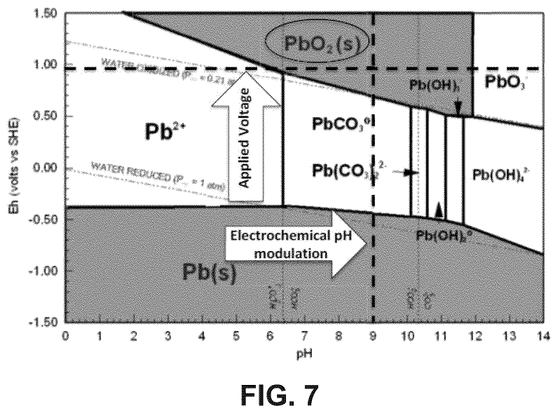

Other target species can be removed under similar mechanisms but under different voltage regions. For example, the Pourbaix diagram for lead (Pb) in FIG. 7 shows that at potentials more negative than about −0.4 V versus NHE and pH regions from 0 to 14, lead is electroplated as a solid (Pb(s)) at the cathode.

In embodiments, a cell potential (Volts (V)) of about 0.6 to about 2.5 Volts is applied to the electrochemical device, which will be split between the cathode and anode. In other embodiments, a cell potential about or in any range between about 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, and 2.5 Volts.

A negative potential (E−) is applied to the cathode, and a positive potential (E+) is applied to the anode. The potential (V) and pH at each of the anode and cathode are measured, and the operating conditions (i.e., the applied potential) are adjusted to obtain a near electrode potential (i.e., anode potential) and pH that corresponds to conditions under which the target species will be electroplated and removed from the aqueous solution. The electrochemical cell is maintained under favorable conditions to effect electroplating of the target ionic species from the aqueous solution at the carbon-based cathode. Table 1 below shows operating conditions, including total applied cell voltage ranges used in one or more embodiments.

The asymmetric electrode configuration and optimized, critical electrode separation distance provide the unexpected benefit, in some applications such as during copper removal from complex solutions with high manganese content, of extended device performance and lifetime, compared to symmetric all carbon-electrode devices with electrode separation distances larger than 5,000 micrometers. While long-term copper removal can be problematic for asymmetric carbon and metal electrode devices, unexpectedly, the devices described herein provide optimal copper removal from solutions with high manganese over extended periods of time. Further, typically, all-carbon devices, with the same separation distances between electrodes and running at 100% duty cycle (always on) may last only between about two and about four weeks. In contrast, devices described herein, at the same separation distance), have lifetimes of about 1 to about 3 years at 100% duty cycle (always on).

TABLE 1
Operating conditions for electroplating target species

| Target species | Cell voltage range (V) |
|---|---|
| Pb | Greater than 1.5 |
| Cu | Greater than 1.2 |

### EXAMPLES

### Example 1: Metal Separation with Metal Anode and Carbon Cathode

Electrochemical devices include a metal-based anode and a carbon-based cathode. The anode is a mixed metal oxide anode formulated from a combination of titanium oxide, ruthenium oxide, and iridium oxide coated on a titanium mesh. The cathode is a carbon felt.

An aqueous input stream that included hexavalent chromium (Cr(VI)), cadmium (Cd), lead (Pb) and copper (Cu) species was flowed into the electrochemical device using the flow rate (gallons per minute, gpm), voltage (V), and pH shown in Table 2 below. The concentration of each target species in parts per million (ppm) was measured in the stream before (input) and after (output) treatment. As shown in Table 2, device performance was sustained for extended periods of time by maintaining the current required to remove high concentrations of metals, in the ppm range, down to trace levels, in the ppb range. Time periods of 1 to 4 hours, as well as 0.25 to 6 months, were used to demonstrate the long-term stability of the systems.

TABLE 2
Operating conditions

| Target | Flow Rate | Voltage | | Input | Output |
|---|---|---|---|---|---|
| Species | (gpm) | (V) | pH | (ppm) | (ppm) |
| Cr(VI) | 0.2 | 1.2 | 1.8 | 200 | 1.98 |
| Cd | 0.013 | 2.2 | 1.71 | 87.7 | 2.7 |
| Pb | 0.0121 | 1.8 | 2.35 | 1.84 | 0.054 |
| Cu | 0.0121 | 1.8 | 2.35 | 3.04 | 0.12 |

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on,” “on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. An electrochemical device comprising:
at least one of a carbonaceous cathode; and
at least one of a metal-containing anode comprising a metal;
wherein a separation distance between the carbonaceous cathode and the metal-containing anode is about 1 to about 5000 micrometers.

2. The electrochemical device of claim 1, further comprising a membrane on one or more of a metal-containing anode of the plurality of a metal-containing anode.

3. The electrochemical device of claim 2, wherein the membrane is an anion exchange membrane.

4. The electrochemical device of claim 2, wherein the membrane is in a form of a film, a layer, a sheet, a coating, or a combination thereof.

5. The electrochemical device of claim 2, wherein the membrane is a bipolar membrane.

6. The electrochemical device of claim 1, further comprising a membrane on one or more of a carbonaceous cathode of the plurality of the carbonaceous cathode.

7. The electrochemical device of claim 6, wherein the membrane is a cation exchange membrane.

8. The electrochemical device of claim 6, wherein the membrane is a bipolar membrane.

9. The electrochemical device of claim 6, wherein the membrane is in a form of a film, a layer, a sheet, a coating, or a combination thereof.

10. The electrochemical device of claim 1, wherein the electrochemical device further comprises a cathode current collector in contact with the carbonaceous cathode.

11. The electrochemical device of claim 10, wherein the cathode current collector comprises graphite, titanium, stainless steel, aluminum, copper, nickel, or a combination thereof.

12. The electrochemical device of claim 10, wherein the cathode current collector is in a form of a film, a layer, a metal sheet, a foil sheet, a mesh sheet, or a combination thereof.

13. The electrochemical device of claim 1, wherein metal-containing anode further comprises a metal oxide arranged on the metal.

14. The electrochemical device of claim 13, wherein the metal oxide comprises one or more metal oxides.

15. The electrochemical device of claim 1, wherein the electrochemical device further comprises an anode current collector in contact with the metal-containing anode.

16. The electrochemical device of claim 15, wherein the anode current collector comprises graphite, titanium, stainless steel, aluminum, copper, nickel, or a combination thereof.

17. The electrochemical device of claim 15, wherein the anode current collector is in a form of a film, a layer, a metal sheet, a foil sheet, a mesh sheet, or a combination thereof.

18. The electrochemical device of claim 1, wherein the electrochemical device further comprises a separator arranged between the carbonaceous cathode and the metal-containing anode.

19. The electrochemical device of claim 18, wherein the separator comprises a dielectric material.

20. The electrochemical device of claim 19, wherein the dielectric material comprises a polymeric material, a cellulosic material, a silica containing material, or a combination thereof.

21. The electrochemical device of claim 20, wherein the polymeric material comprises polyethylene.

22. The electrochemical device of claim 1, wherein the carbonaceous cathode is a carbon felt, a woven carbon cloth, a carbon film, or a non-woven.

23. The electrochemical device of claim 1, wherein each carbonaceous cathode of the plurality of carbonaceous cathodes is the same carbonaceous cathode.

24. The electrochemical device of claim 1, wherein each carbonaceous cathode of the plurality of carbonaceous cathode has a surface area of:
about 0.1 to about 5 square meters per gram; or
about 700 to about 2300 square meters per gram.

25. An electrochemical device, comprising:
a plurality of a cathode comprising a carbon felt;
a plurality of an anode comprising a titanium mesh core coated with an alloy of titanium oxide, ruthenium oxide and iridium oxide; and
a membrane on one or more of the anode comprising the titanium mesh core coated with the alloy of titanium oxide, ruthenium oxide and iridium oxide;
wherein a separation distance between the cathode comprising the carbon felt and the anode comprising the platinum mesh core coated with the ruthenium oxide and iridium oxide is about 1 to about 5000 micrometers.

26. The electrochemical device of claim 25, wherein the membrane is an anion exchange membrane.

27. The electrochemical device of claim 25, wherein the membrane is a bipolar membrane.

28. The electrochemical device of claim 25, wherein each cathode of the plurality of cathode comprising the carbon felt is the same carbon felt.

29. The electrochemical device of claim 25, wherein each cathode of the plurality of cathode comprising the carbon felt has a surface area of:
about 0.1 to about 5 square meters per gram; or
about 700 to about 2300 square meters per gram.
